(19) United States
(12) Patent Application Publication
(10) Pub. No.: US 2025/0162222 A1
(43) Pub. Date: May 22, 2025

(54) Injection Molding Device

(71) Applicant: SEIKO EPSON CORPORATION, Tokyo (JP)

(72) Inventor: Taiki AKIYAMA, Azumino (JP)

(21) Appl. No.: 18/953,250

(22) Filed: Nov. 20, 2024

(30) Foreign Application Priority Data
Nov. 21, 2023 (JP) 2023-197183

(51) Int. Cl. B29C 45/53; B29C 45/17; B29C 45/76

(52) U.S. Cl. CPC B29C 45/531; B29C 45/76; B29C 2045/1794

(57) ABSTRACT

A driving force transmission unit includes a rotary plate provided with a rotation axis at an eccentric position, and a support portion having a hole portion through which the rotation axis passes and being configured to support a plunger. The hole portion extends in a moving direction of the plunger. The support portion swings in an extending direction of the hole portion by rotation of the rotary plate. When dispensing processing is terminated, an angle is larger than 90 degrees and smaller than 180 degrees, the angle being formed between a linear line connecting the rotation axis and a center of the rotary plate to each other and the moving direction of the plunger as viewed in a direction of the rotation axis. A control unit controls a rotation speed of a motor according to the angle during the dispensing processing.

The present application is based on, and claims priority from JP Application Serial Number 2023-197183, filed Nov. 21, 2023, the disclosure of which is hereby incorporated by reference herein in its entirety.

### BACKGROUND

### 1. Technical Field

The present disclosure relates to an injection molding device.

### 2. Related Art

There has been known an injection molding device that molds a molded item by injecting a material, which is plasticized by a plasticization unit, into a cavity, and curing the material.

For example, JP-A-2021-104600 describes an injection molding machine including an injection control unit including a cylinder, a plunger that moves inside the cylinder, and a plunger driving unit that drives the plunger.

In the injection molding machine described above, a cavity is filled with a plasticized material, and then a pressure applied to the plasticized material filled in the cavity is held. In this pressure holding phase, a load is applied to a motor of the plunger driving unit. Thus, the size increase may be required for the motor.

### SUMMARY

According one aspect of the present disclosure, an injection molding device includes a plasticization unit configured to plasticize a material to generate a plasticized material a nozzle having a nozzle opening and being configured to dispense the plasticized material through the nozzle opening, a sucking/dispensing unit including a cylinder communicating with the nozzle opening and being coupled to a flow path in which the plasticized material flows, a plunger configured to reciprocate inside the cylinder, a motor configured to drive the plunger, and a driving force transmission unit configured to transmit a driving force of the motor to the plunger, and a control unit configured to control the motor, wherein the control unit executes sucking processing of sucking the plasticized material into the cylinder by controlling a rotation speed of the motor and moving the plunger in a direction away from the flow path, and dispensing processing of dispensing the plasticized material inside the cylinder to the nozzle by controlling the rotation speed of the motor and moving the plunger in a direction approaching the flow path, the driving force transmission unit includes a rotary plate provided with a rotation axis at an eccentric position, and a support portion having a hole portion through which the rotation axis passes and being configured to support the plunger, the hole portion extends in a moving direction of the plunger, the support portion swings in an extending direction of the hole portion by rotation of the rotary plate, when the dispensing processing is terminated, an angle is larger than 90 degrees and smaller than 180 degrees, the angle being formed between a linear line connecting the rotation axis and a center of the rotary plate to each other and the moving direction of the plunger as viewed in a direction of the rotation axis, and the control unit controls the rotation speed of the motor according to the angle during the dispensing processing.

### BRIEF DESCRIPTION OF THE DRAWINGS

FIG. 1 is a side view schematically illustrating an injection molding device according to the present embodiment.

FIG. 2 is a cross-sectional view schematically illustrating the injection molding device according to the present embodiment.

FIG. 3 is a perspective view schematically illustrating a flat screw of the injection molding device according to the present embodiment.

FIG. 4 is a view schematically illustrating a barrel of the injection molding device according to the present embodiment.

FIG. 5 is a perspective view schematically illustrating a sucking/dispensing unit of the injection molding device according to the present embodiment.

FIG. 6 is a perspective view schematically illustrating the sucking/dispensing unit of the injection molding device according to the present embodiment.

FIG. 7 is a cross-sectional view schematically illustrating the sucking/dispensing unit of the injection molding device according to the present embodiment.

FIG. 8 is a flowchart for describing an operation of the injection molding device according to the present embodiment.

FIG. 9 is a cross-sectional view for describing dispensing processing of the injection molding device according to the present embodiment.

FIG. 10 is a view for describing the dispensing processing of the injection molding device according to the present embodiment.

FIG. 11 is a perspective view schematically illustrating a plunger of an injection molding device according to a first modification example of the present embodiment.

FIG. 12 is a perspective view schematically illustrating a plunger of an injection molding device according to a second modification example of the present embodiment.

### DESCRIPTION OF EMBODIMENTS

A preferred embodiment of the present disclosure is described in detail below with reference to the drawings. Note that the embodiment described below do not unduly limit the content of the present disclosure described in the claims. In addition, not all the configurations described below are essential constituent elements of the present disclosure.

### 1. Injection Molding Device

### 1.1. Overall Configuration

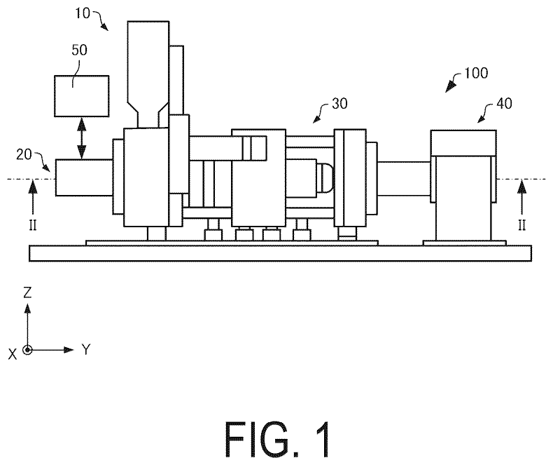

First, an injection molding device according to the embodiment is described with reference to the drawings. FIG. 1 is a side view schematically illustrating an injection molding device 100 according to the present embodiment. Note that, an x-axis, a y-axis, and a z-axis are illustrated in FIG. 1 as three axes orthogonal to each other. The X-axis direction and the Y-axis direction are horizontal directions, for example. The Z-axis direction is a vertical direction, for example.

As illustrated in FIG. 1, the injection molding device 100 includes a material supply unit 10, an injection unit 20, a molding unit 30, a clamping unit 40, and a control device 50.

The material supply unit 10 supplies a material being a raw material to the injection unit 20. For example, the material supply unit 10 is configured by a hopper. For example, a form of the material supplied from the material supply unit 10 is a pellet form or a powder form. For example, the material supplied from the material supply unit 10 is an acrylonitrile butadiene styrene (ABS) resin.

The injection unit 20 plasticizes the material supplied from the material supply unit 10 to obtain a plasticized material. Then, the injection unit 20 injects the plasticized material toward the molding unit 30.

Note that plasticization is a concept includes melting, and involves a change from a solid body to a state having fluidity. Specifically, in a case of a material where glass transition occurs, plasticization involves raising a temperature of the material to the glass transition temperature or above. In a case of a material where glass transition does not occur, plasticization involves raising a temperature of the material to its melting point or above.

In the molding unit 30, a cavity corresponding to a shape of a molded item is formed. The plasticized material injected from the injection unit 20 flows into the cavity. Then, the plasticized material is cooled and solidified, and thus a molded item is generated.

The clamping unit 40 opens and closes the molding unit 30. After the plasticized material is cooled and solidified, the clamping unit 40 opens the molding unit 30. With this, the molded item is discharged to the outside.

The control device 50 is composed of a computer including a processor, a main storage apparatus, and an input/output interface for performing input and output of signals with external parts, for example. The control device 50 implements various functions with the processor executing the program read in the main storage apparatus, for example. Specifically, the control device 50 controls the injection unit 20 and the clamping unit 40. Note that the control device 50 may be composed of a combination of a plurality of circuits, not the computer.

### 1.2. Specific Configuration

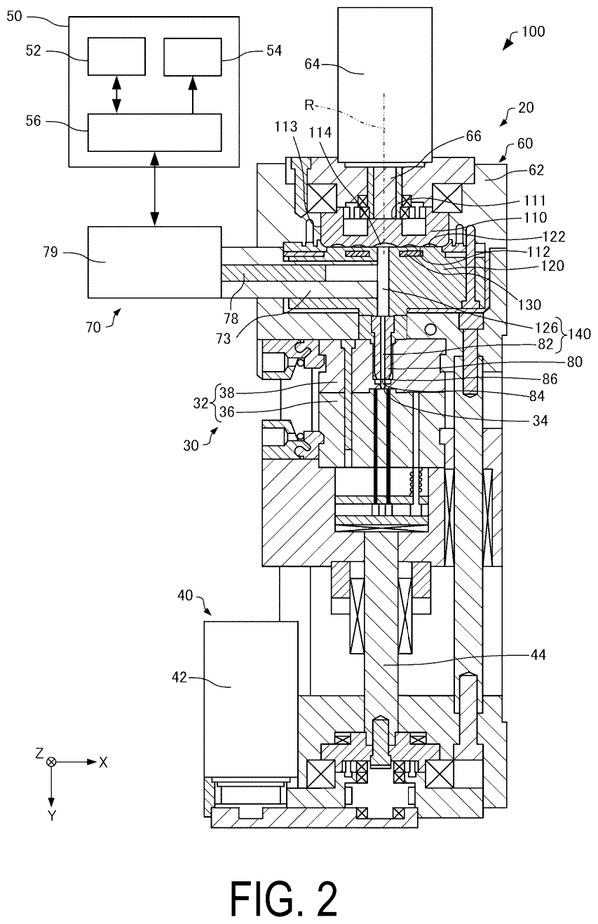

FIG. 2 is a cross-sectional view schematically illustrating the injection molding device 100, which is taken along the line II-II in FIG. 1. As illustrated in FIG. 2, for example, the injection unit 20 includes a plasticization unit 60, a sucking/dispensing unit 70, and a nozzle 80.

The plasticization unit 60 is configured to plasticize at least a part of the material supplied from the material supply unit 10, generate paste-like plasticized material having fluidity, and guide the plasticized material to the sucking/dispensing unit 70. For example, the plasticization unit 60 includes a screw case 62, a driving motor 64, a flat screw 110, a barrel 120, and a heater 130.

The screw case 62 is a casing body that accommodates the flat screw 110. The flat screw 110 is accommodated in a space surrounded by the screw case 62 and the barrel 120.

The driving motor 64 is coupled to the screw case 62. The driving motor 64 rotates the flat screw 110. For example, the driving motor 64 is a servo motor. A shaft 66 of the driving motor 64 is coupled to the flat screw 110. The driving motor 64 is controlled by a control unit 56 of the control device 50.

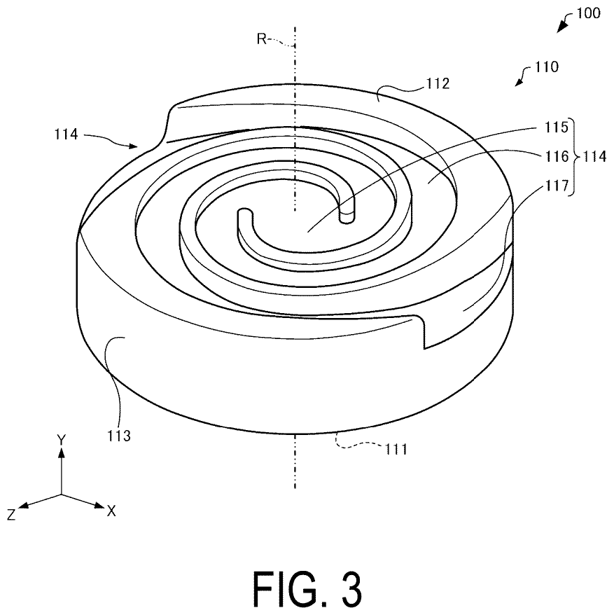

The flat screw 110 has such a substantially columnar shape that a dimension in a direction of a rotation axis R is smaller than a dimension in a direction orthogonal to the direction of the rotation axis R. In the illustrated example, the rotation axis R is parallel to the Y axis. The flat screw 110 rotates about the rotation axis R by a torque generated by the driving motor 64. For example, the flat screw 110 includes a shaft surface 111 coupled to the shaft 66, a groove formation surface 112 on a side opposite to the shaft surface 111, and a coupling surface 113 coupling the shaft surface 111 and the groove formation surface 112 with each other. Herein, FIG. 3 is a perspective view schematically illustrating the flat screw 110. Note that, for the sake of convenience, FIG. 3 illustrates a state obtained by inverting the vertical position relationship in the state illustrated in FIG. 2.

As illustrated in FIG. 3, a first groove 114 is formed in the groove formation surface 112 of the flat screw 110. For example, the first groove 114 includes a center portion 115, a coupling portion 116, and a material introduction portion 117. The center portion 115 faces a communication hole 126 formed in the barrel 120. The center portion 115 communicates with the communication hole 126. The coupling portion 116 couples the center portion 115 and the material introduction portion 117 to each other. In the illustrated example, the coupling portion 116 is formed spirally from the center portion 115 toward the outer circumference of the groove formation surface 112. The material introduction portion 117 is formed at the outer circumference of the groove formation surface 112. In other words, the material introduction portion 117 is formed at the coupling surface 113 of the flat screw 110. The material supplied from the material supply unit 10 is introduced from the material introduction portion 117 to the first groove 114, passes through the coupling portion 116 and the center portion 115, and then is transported to the communication hole 126 formed in the barrel 120. In the illustrated example, two first grooves 114 are formed.

Note that the number of the first grooves 114 is not particularly limited. Although omitted in illustration, three or more first grooves 114 may be formed, or only one first groove 114 may be formed.

Further, although omitted in illustration, the plasticization unit 60 may include an elongated in-line screw having a helical groove in a side surface thereof, in place of the flat screw 110. Further, the plasticization unit 60 may plasticize the material by rotation of the in-line screw.

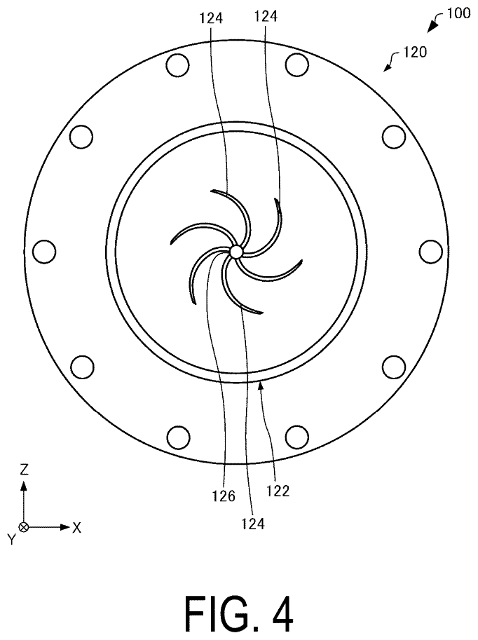

As illustrated in FIG. 2, the barrel 120 is provided to face the flat screw 110. The barrel 120 includes a facing surface 122 that faces the groove formation surface 112 of the flat screw 110. The facing surface 122 faces the groove formation surface 112 in the Y-axis direction. In the center of the facing surface 122, the communication hole 126 is formed. Herein, FIG. 4 is a view schematically illustrating the barrel 120.

As illustrated in FIG. 4, a second groove 124 and the communication hole 126 are formed in the facing surface 122 of the barrel 120. A plurality of second grooves 124 are formed. In the illustrated example, six second grooves 124 are formed, but the number thereof is not particularly limited. The plurality of second grooves 124 are formed around the communication hole 126 as viewed in the Y-axis direction. One end of the second groove 124 is coupled to the communication hole 126, and extends spirally from the communication hole 126 to the outer circumference of the facing surface 122. The second groove 124 includes a function of guiding the plasticized material to the communication hole 126. The communication hole 126 causes the plasticized material to flow to the outside of the barrel 120.

Note that the shape of the second groove 124 is not particularly limited, and may be a linear shape, for example. Further, the one end of the second groove 124 may not be coupled to the communication hole 126. Further, the second groove 124 may not be formed in the facing surface 122. However, in consideration of efficient guidance of the plasticized material to the communication hole 126, the second groove 124 may be formed in the facing surface 122.

As illustrated in FIG. 2, the heater 130 is provided to the barrel 120. The heater 130 heats the material supplied between the flat screw 110 and the barrel 120. The heater 130 heats the material supplied to the first groove 114. The heater 130 is controlled by the control unit 56 of the control device 50. The plasticization unit 60 generates the plasticized material while transporting the material toward the communication hole 126 by the flat screw 110, and the barrel 120, and heating the material by the heater 130, and causes the plasticized material being generated to flow from the communication hole 126 to the sucking/dispensing unit 70.

The sucking/dispensing unit 70 includes a cylinder 73 and a plunger 78. The sucking/dispensing unit 70 guides the plasticized material positioned at the communication hole 126 into the cylinder 73 by moving the plunger 78 in the −X-axis direction away from the communication hole 126, and measures the weight thereof inside the cylinder 73. Then, the sucking/dispensing unit 70 injects the plasticized material in the cylinder 73 to the molding unit 30 through the nozzle 80 by moving the plunger 78 in the +X-axis direction approaching the communication hole 126. Details of the sucking/dispensing unit 70 are described later. Note that, in FIG. 2, the sucking/dispensing unit 70 is illustrated in a simplified manner.

A nozzle hole 82 is formed in the nozzle 80. The nozzle hole 82 communicates with the communication hole 126. The nozzle hole 82 includes a nozzle opening 84 through which the plasticized material is injected. The nozzle 80 dispenses the plasticized material supplied from the plasticization unit 60, from the nozzle opening 84 toward a mold 32 of the molding unit 30. Specifically, the plasticized material measured inside the cylinder 73 is fed from the sucking/dispensing unit 70 to the nozzle hole 82 through the communication hole 126. Then, the plasticized material is injected from the nozzle opening 84 of the nozzle hole 82 to the molding unit 30.

The nozzle hole 82 and the communication hole 126 form a flow path 140 in which the plasticized material flows. In the illustrated example, the longitudinal direction of the flow path 140 corresponds to the Y-axis direction. The cylinder 73 is coupled to the flow path 140. In the illustrated example, the cylinder 73 extends in the X-axis direction.

As illustrated in FIG. 2, the nozzle 80 includes an opening/closing mechanism 86 that opens and closes the nozzle opening 84. The opening/closing mechanism 86 is configured to open the nozzle opening 84 when a pressure in the flow path 140 is larger than a predetermined pressure (hereinafter, also referred to as a “nozzle opening pressure”). For example, the opening/closing mechanism 86 is configured by a valve or the like.

The molding unit 30 includes the mold 32. The mold 32 is a molding die. The plasticized material fed to the nozzle hole 82 is injected from the nozzle hole 82 to a cavity 34 of the mold 32. Specifically, the mold 32 includes a movable die 36 and a fixed die 38 that face each other, and includes the cavity 34 between the movable die 36 and the fixed die 38. The cavity 34 is a space corresponding to a shape of a molded item. The material of the movable die 36 and the fixed die 38 is metal. Note that the material of the movable die 36 and the fixed die 38 may be ceramic or a resin.

For example, the clamping unit 40 includes a die driving unit 42 and a ball screw unit 44. For example, the die driving unit 42 is configured by a motor, a gear, and the like. The die driving unit 42 is coupled to the movable die 36 via the ball screw unit 44. The die driving unit 42 is controlled by the control unit 56 of the control device 50. The ball screw unit 44 transmits a driving force generated by driving of the die driving unit 42 to the movable die 36. The clamping unit 40 opens and closes the molding unit 30 by moving the movable die 36 by the die driving unit 42 and the ball screw unit 44.

For example, the control device 50 includes a storage unit 52, a display unit 54, and the control unit 56.

The storage unit 52 stores a program, data, and the like for executing various types of calculation processing and control processing by the control unit 56. Further, the storage unit 52 is used as a work region of the control unit 56. For example, the storage unit 52 is configured by a random access memory, a read-only memory (ROM), or the like.

According to an instruction from the control unit 56, the display unit 54 displays various images. For example, the display unit 54 is configured by a liquid crystal display (LCD), an organic electroluminescence (EL) display, an electrophoretic display (EPD), a touch-panel display, or the like.

The control unit 56 executes various types of calculation processing and control processing according to the program stored in the storage unit 52, for example. For example, the control unit 56 is configured by a central processing unit (CPU), a micro processing unit (MPU), a digital signal processor (DSP), an application specific integrated circuit (ASIC), or the like.

### 1.3. Sucking/Dispensing Unit

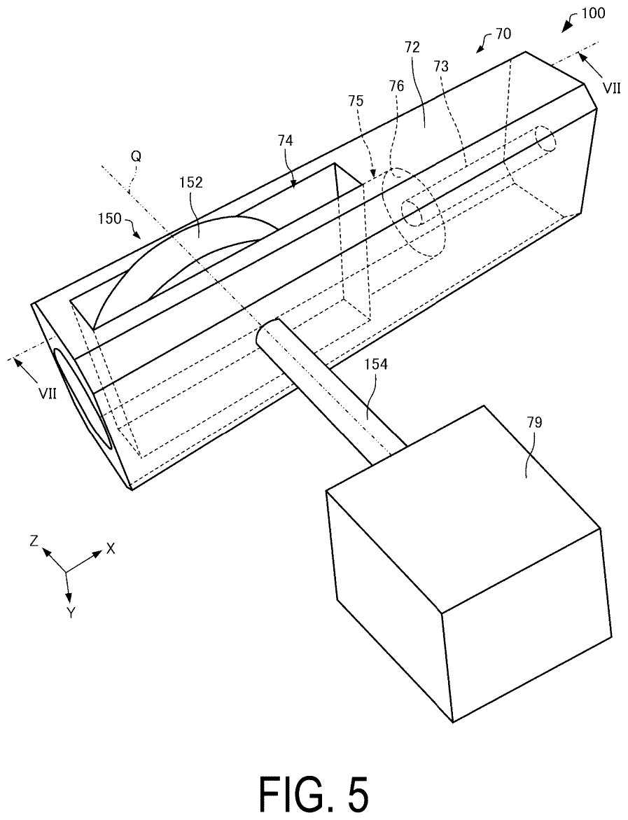

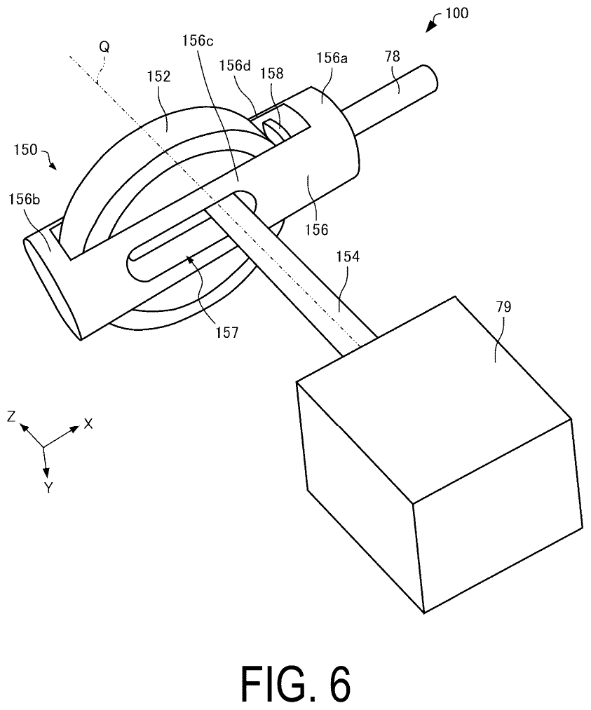

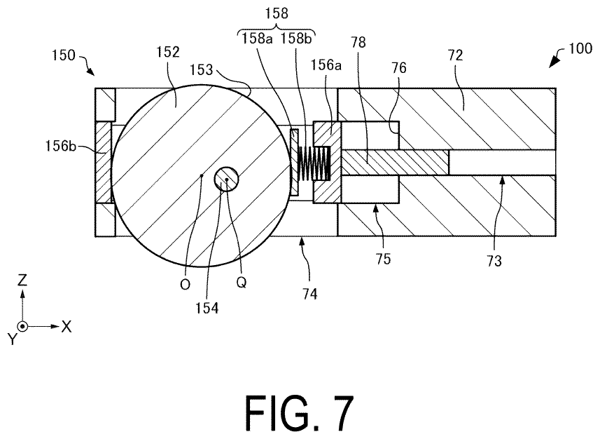

FIG. 5 and FIG. 6 are perspective views schematically illustrating the sucking/dispensing unit 70 of the injection molding device 100 according to the present embodiment. FIG. 7 is a cross-sectional view taken along the line VII-VII in FIG. 5 schematically illustrating the sucking/dispensing unit 70 of the injection molding device 100 according to the present embodiment.

As illustrated in FIG. 5 to FIG. 7, for example, the sucking/dispensing unit 70 includes a casing body 72, the plunger 78, a motor 79, and a driving force transmission unit 150. Note that, for the sake of convenience, in FIG. 5, the internal structure of the casing body 72 is indicated with the broken line. Further, in FIG. 6, the casing body 72 is omitted illustration.

As illustrated in FIG. 5, the shape of the casing body 72 is a substantially rectangular parallelepiped shape. The casing body 72 accommodates the plunger 78 and the driving force transmission unit 150. The casing body 72 forms the cylinder 73. The cylinder 73 communicates with the nozzle opening 84, and is coupled to the flow path 140 in which the plasticized material flows. For example, the cylinder 73 extends in the −X-axis direction from the flow path 140.

The plunger 78 reciprocates inside the cylinder 73. In the illustrated example, the plunger 78 reciprocates in the X-axis direction inside the cylinder 73. The +X-axis direction is a direction in which the plunger 78 approaches the flow path 140. The −X-axis direction is a direction in which the plunger 78 is away from the flow path 140. The plunger 78 is a bar-like member extending in the X-axis direction. For example, the plunger 78 is configured by one member.

The motor 79 drives the plunger 78 via the driving force transmission unit 150. A type of the motor 79 is not particularly limited as long as the plunger 78 is driven. The motor 79 is controlled by the control unit 56.

The driving force transmission unit 150 transmits a force of the motor 79 to the plunger 78. As illustrated in FIG. 6 and FIG. 7, for example, the driving force transmission unit 150 includes a rotary plate 152, a shaft 154, a support portion 156, and a biasing portion 158.

As illustrated in FIG. 5, the rotary plate 152 is provided to a first opening portion 74 formed in the casing body 72. For example, the shape of the rotary plate 152 is a disk-like shape. The rotary plate 152 rotates about a rotation axis Q. In the illustrated example, the rotation axis Q is parallel to the Y axis. As illustrated in FIG. 7, the rotation axis Q is provided at an eccentric position on the rotary plate 152. In other words, as viewed in the Y-axis direction, the rotation axis Q is away from a center O of the rotary plate 152.

The shaft 154 couples the rotary plate 152 and the motor 79 to each other. In the illustrated example, the shaft 154 is a bar-like member extending in the Y-axis direction. The shaft 154 rotates about the rotation axis Q by driving of the motor 79. As the shaft 154 rotates, the rotary plate 152 rotates. The rotation axis Q is a center axis of the shaft 154.

The support portion 156 supports the plunger 78. As illustrated in FIG. 6 and FIG. 7, the support portion 156 includes a first wall portion 156a, a second wall portion 156b, a third wall portion 156c, and a fourth wall portion 156d.

The first wall portion 156a of the support portion 156 is provided between the rotary plate 152 and the plunger 78. The plunger 78 is coupled to the first wall portion 156a. As illustrated in FIG. 5 and FIG. 7, a second opening portion 75 in which the first wall portion 156a is inserted is formed in the casing body 72. The second opening portion 75 is positioned between the cylinder 73 and the first opening portion 74. A dimension of the second opening portion 75 in a direction orthogonal to the X-axis direction is larger than a dimension of the cylinder 73 in a direction orthogonal to the X-axis direction. With this, the casing body 72 includes a step surface 76.

As illustrated in FIG. 6 and FIG. 7, the second wall portion 156b of the support portion 156 is arranged to face the first wall portion 156a. In the X-axis direction, the rotary plate 152 is provided between the first wall portion 156a and the second wall portion 156b. In the example illustrated in FIG. 7, the second wall portion 156b contacts with a side surface 153 of the rotary plate 152.

The third wall portion 156c and the fourth wall portion 156d of the support portion 156 couple the first wall portion 156a and the second wall portion 156b to each other. In the Y-axis direction, the rotary plate 152 is provided between the third wall portion 156c and the fourth wall portion 156d. As illustrated in FIG. 6, a hole portion 157 is formed in the third wall portion 156c. The hole portion 157 passes in the Y-axis direction through the third wall portion 156c. The rotation axis Q and the shaft 154 passes through the hole portion 157. The hole portion 157 extends in the X-axis direction. The support portion 156 swings in the X-axis direction being an extending direction of the hole portion 157 by rotation of the rotary plate 152. As the support portion 156 swings, the plunger 78 moves in the X-axis direction.

As illustrated in FIG. 7, the biasing portion 158 is provided between the rotary plate 152 and the first wall portion 156a. The biasing portion 158 includes a contact portion 158a and a spring 158b. The contact portion 158a contacts with the side surface 153 of the rotary plate 152. For example, the shape of the contact portion 158a is a plate-like shape. The contact portion 158a is away from the first wall portion 156a. The spring 158b couples the contact portion 158a and the first wall portion 156a to each other. Note that the position of the biasing portion 158 is not limited to a position between the rotary plate 152 and the first wall portion 156a.

The contact portion 158a of the biasing portion 158 moves in the +X-axis direction by rotation of the rotary plate 152. With this, the spring 158b contracts, and the biasing portion 158 biases the first wall portion 156a in the +X-axis direction. A biasing force of the biasing portion 158 is smaller than a reaction force of the plunger 78 against the nozzle opening pressure. In other words, when a pressure in the flow path 140 is equivalent to the nozzle opening pressure, the biasing portion 158 cannot move the first wall portion 156a in the +X-axis direction. “A biasing force of the biasing portion 158” is a force of the biasing portion 158 pressing the first wall portion 156a in the +X-axis direction. “A reaction force of the plunger 78” is a force of the plunger 78 pressing the first wall portion 156a in the −X-axis direction by a pressure in the flow path 140.

### 1.4. Operations

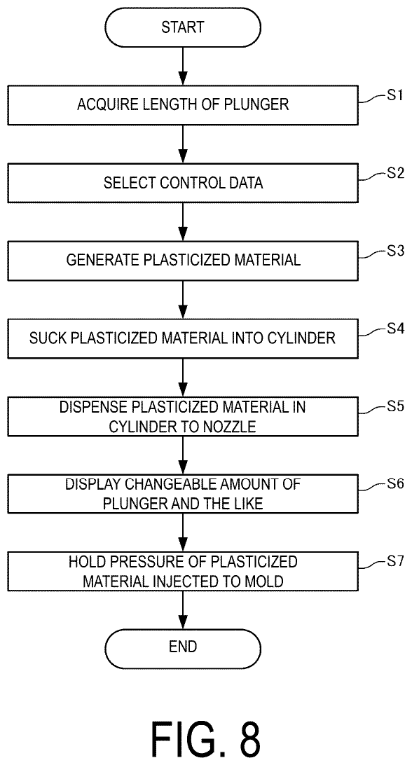

FIG. 8 is a flowchart for describing an operation of the injection molding device 100. Specifically, FIG. 8 is a flowchart for describing processing of the control unit 56.

A user outputs a processing start signal for starting the processing to the control unit 56 by operating an operation unit not illustrated in the drawings. For example, the processing start signal includes information relating to a type of a material stored in the material supply unit 10 and information relating to a size of the plunger 78 in the X-axis direction (hereinafter, simply referred to as a “length”). The operation unit is configured by a mouse, a keyboard, a touch panel, or the like. When the control unit 56 receives the processing start signal, the processing is started.

First, as illustrated in FIG. 8. the control unit 56 executes processing of acquiring the length of the plunger 78 in Step S1. Specifically, the control unit 56 acquires the length of the plunger 78 from the processing start signal. The length of the plunger 78 is set by a user.

Subsequently, in Step S2, the control unit 56 executes processing of selecting control data for controlling a rotation speed of the motor 79 according to the detected length of the plunger 78, from data stored in the storage unit 52. The control data includes information relating to a time series of the rotation speed of the motor 79. In the storage unit 52, the control data is stored for each length of the plunger 78.

Note that the control unit 56 may generate the control data according to the detected length of the plunger 78, instead of reading the control data from the storage unit 52. For example, the control data may be generated according to the length of the plunger 78, based on information relating to a time series of the rotation speed of the motor 79, which is stored in advance in the storage unit 52.

Subsequently, in Step S3, the control unit 56 executes processing of generating the plasticized material. Specifically, the control unit 56 controls the driving motor 64 to supply the material between the flat screw 110 and the barrel 120, and controls the heater 130 to plasticize the material. In this manner, the plasticized material is generated.

Subsequently, in Step S4, the control unit 56 executes sucking processing of sucking the plasticized material into the cylinder 73 by controlling the rotation speed of the motor 79, based on the control data, and moving the plunger 78 in the −X-axis direction. With this, a predetermined amount of the plasticized material is sucked into the cylinder 73.

The control unit 56 executes the sucking processing in Step S4 while detecting a pressure in the flow path 140. For example, the control unit 56 detects a pressure in the flow path 140 while detecting a torque value of the motor 79. Although omitted in illustration, the control unit 56 may detect a pressure in the flow path 140, based on a pressure sensor provided in the flow path 140, which is omitted in illustration. When the sucking processing is terminated, the control unit 56 executes the sucking processing so that a biasing force of the biasing portion 158 is larger than a reaction force of the plunger 78.

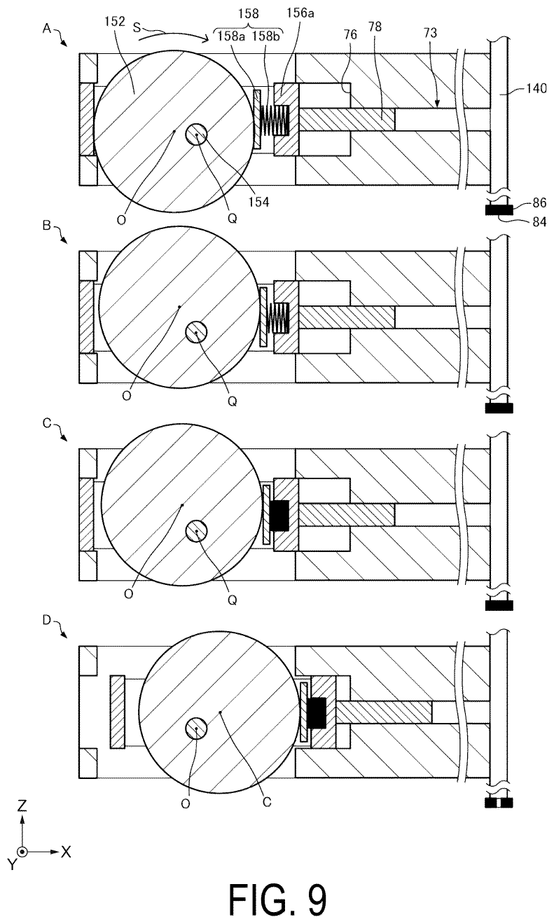

Next, in Step S5, the control unit 56 executes the dispensing processing of dispensing the plasticized material in the cylinder 73 to the nozzle 80 by controlling the rotation speed of the motor 79, based on the control data, and moving the plunger 78 in the +X-axis direction. Herein, FIG. 9 is a cross-sectional view for describing the dispensing processing. As illustrated in FIG. 9, for example, the dispensing processing can be divided in to Section A, Section B, Section C, and Section D. In Section A to Section D, the rotary plate 152 is rotated in a direction S.

In Section A, a biasing force of the biasing portion 158 is larger than a reaction force of the plunger 78. Thus, the spring 158b of the biasing portion 158 does not contract, and the plunger 78 moves in the +X-axis direction. As the plunger 78 moves, a pressure in the flow path 140 is increased, but does not arrive at the nozzle opening pressure.

In Section B, a biasing force of the biasing portion 158 is equal to a reaction force of the plunger 78, and movement of the plunger 78 in the +X-axis direction is stopped. The spring 158b of the biasing portion 158 starts to contract.

In Section C, while the spring 158b completely contracts, the plunger 78 moves again in the +X-axis direction. As the plunger 78 moves, a pressure in the flow path 140 is increased, but does not arrive at the nozzle opening pressure.

In Section D, the plunger 78 further moves in the +X-axis direction, and a pressure in the flow path 140 arrives at the nozzle opening pressure. With this, the plasticized material that is sucked and measured in the cylinder 73 during the sucking processing is injected from the nozzle opening 84 toward the mold 32. Then, the control unit 56 terminates the dispensing processing.

Herein, FIG. 10 is a view for describing the dispensing processing as viewed in the Y-axis direction, specifically. For the sake of convenience, in FIG. 10, the members other than the rotary plate 152 and the shaft 154 are omitted in illustration. In FIG. 10, the states in Section C and Section D are illustrated.

As illustrated in FIG. 10, during the dispensing processing, an angle θ is changed. The angle θ is an angle formed between a first linear line L1 and a second linear line L2 as viewed in the Y-axis direction. The first linear line L1 is a linear line connecting the rotation axis Q and the center O of the rotary plate 152 to each other. The second linear line L2 is a linear line that is parallel to the X axis and passes through the rotation axis Q. An extending direction of the second linear line L2 is a moving direction of the plunger 78. In Section A, Section B, Section C, and Section D, the angle θ is the smallest in Section A, and is increased in the order of, Section B, Section C, and Section D. For example, in Section A, the angle θ is larger than 0 degrees and smaller than 90 degrees.

During the dispensing processing, the control unit 56 controls the rotation speed of the motor 79 according to the angle θ. For example, the control unit 56 controls the rotation speed of the motor 79 according to the angle θ so that the moving speed of the plunger 78 in the +X-axis direction is constant in Section C.

When the dispensing processing is terminated, in other words, Section D is terminated, the angle θ is larger than 90 degrees and smaller than 180 degrees, preferably, equal to or larger than 100 degrees and equal to or smaller than 170 degrees, more preferably, equal to or larger than 110 degrees and equal to or smaller than 160 degrees, further more preferably, equal to or larger than 120 degrees and equal to or smaller than 150 degrees. When the dispensing processing is terminated, the control unit 56 controls the motor 79 so that the angle θ is larger than 90 degrees and smaller than 180 degrees.

Subsequently, in Step S6, the control unit 56 executes processing of causing the display unit 54 to display a changeable amount of the length of the plunger 78, based on chronological data relating to a torque value of the motor 79 during the dispensing processing.

Specifically, the control unit 56 causes the storage unit 52 to store chronological data relating to a torque value of the motor 79 during the dispensing processing. Then, after the dispensing processing is terminated, the control unit 56 reads chronological data from the storage unit 52, and compares the chronological data with the control data for each length of the plunger 78, which is stored in advance in the storage unit 52. Based on the comparison, the control unit 56 decides a changeable amount of the length of the plunger 78, and causes the display unit 54 to display the changeable amount. “The changeable amount of the length of the plunger 78” is a length of the plunger 78 that enables execution of the dispensing processing while a load of the motor 79 is suppressed to a predetermined value or less.

Further, the control unit 56 executes processing of calculates at least one of a maximum injection force according to the length of the plunger 78, a maximum held pressure, a maximum pressure holding time, or a moving speed of the plunger 78, based on chronological data relating to a torque value of the motor 79 during the dispensing processing, and causing the display unit 54 to display the calculated value.

Note that “the maximum injection force” is a maximum injection force applied in a direction of opening the mold 32 when the plasticized material is injected to the mold 32. “The maximum held pressure” is a maximum held pressure applied to the plasticized material injected to the mold 32. “The maximum pressure holding time is a maximum time during which a pressure is held. “The moving speed of the plunger 78” is a moving speed of the plunger 78 in the X-axis direction. The display unit 54 may display the maximum moving speed of the plunger 78.

Subsequently, in Step S7, the control unit 56 executes processing of applying a pressure to the plasticized material injected to the mold 32 and holding a pressure. For example, the control unit 56 adds, to the plasticized material injected to the mold 32, a pressure equal to or larger than a pressure in the flow path 140 at the time of terminating the dispensing processing. As the angle θ is closer to 180 degrees, a load torque and an output of the motor 79 can be suppressed. Further, a load torque and output to the motor 79 is suppressed, and thus a pressure holding time can be increased. During the pressure holding processing, the moving speed of the plunger 78 in the +X-axis direction is smaller as compared to that during the dispensing processing. During the pressure holding processing, movement of the plunger 78 in the +X-axis direction may be stopped. After a predetermined time elapses, the control unit 56 terminates the pressure holding processing.

Then, the control unit 56 terminates the processing. Note that the order of Step S6 and Step S7 is not particularly limited.

### 1.5. Operations and Effects

In the injection molding device 100, the driving force transmission unit 150 includes the rotary plate 152 that is provided with the rotation axis Q at the eccentric position and the support portion 156 that includes the hole portion 157 through which the rotation axis Q passes and supports the plunger 78. The hole portion 157 extends in the moving direction of the plunger 78. The support portion 156 swings an extending direction of the hole portion 157 by rotation of the rotary plate 152. When the dispensing processing is terminated, an angle θ is larger than 90 degrees and smaller than 180 degrees, the angle θ being formed between the first linear line L1 connecting the rotation axis Q and the center O of the rotary plate 152 to each other and the moving direction of the plunger 78 as viewed in the direction of the rotation axis Q. The control unit 56 controls a rotation speed of the motor 79 according to the angle θ during the dispensing processing.

Thus, in the injection molding device 100, a pressing force of the plunger 78 in the +X-axis direction can be increased as compared to a case in which the angle θ is equal to or smaller than 90 degrees. Therefore, a held pressure in a pressure holding phase can be increased without increasing the capacity of the motor 79.

In the injection molding device 100, according to the detected length of the plunger 78, the control unit 56 executes the processing of generating the control data for controlling the rotation speed of the motor 79 or the processing of selecting the control data from data stored in the storage unit 52. Thus, in the injection molding device 100, the sucking processing and the dispensing processing can be executed based on the control data according to the length of the plunger 78.

In the injection molding device 100, the control unit 56 executes the processing of causing the display unit 54 to display a changeable amount of the length of the plunger 78, based on chronological data relating to a torque value of the motor 79 during the dispensing processing. Thus, a user of the injection molding device 100 can be notified of a changeable amount of the length of the plunger 78.

In the injection molding device 100, the control unit 56 executes the processing of causing the display unit 54 to display at least one of a maximum injection force according to the length of the plunger 78, a maximum held pressure, a maximum pressure holding time, or a moving speed of the plunger. Thus, a user of the injection molding device 100 can be notified of at least one of a maximum injection force according to the length of the plunger 78, a maximum held pressure, a maximum pressure holding time, or a moving speed of the plunger.

In the injection molding device 100, the support portion 156 includes the first wall portion 156a that is provided between the rotary plate 152 and the plunger 78 and is coupled to the plunger 78. The driving force transmission unit 150 includes the biasing portion 158 that is provided between the first wall portion 156a and the rotary plate 152 and biases the first wall portion 156a in a direction approaching the flow path 140. The nozzle 80 includes the opening/closing mechanism 86 that opens and closes the nozzle opening 84. The opening/closing mechanism 86 is configured to open the nozzle opening 84 when a pressure in the flow path 140 is larger than the nozzle opening pressure. A biasing force of the biasing portion 158 is smaller than a reaction force of the plunger 78 against the nozzle opening pressure. Thus, in the injection molding device 100, acceleration of the motor 79 can be completed before the plasticized material is injected from the nozzle 80. For example, the plunger 78 can be moved at a constant speed. With this, the injection rate of the plasticized material can be normalized.

In the injection molding device 100, the control unit 56 executes the sucking processing while a pressure in the flow path 140. When the sucking processing is terminated, a biasing force of the biasing portion 158 is larger than a reaction force of the plunger 78 against a pressure in the flow path 140. Thus, in the injection molding device 100, the dispensing processing can be started while the plunger 78 can be moved in the +X-axis direction by a biasing force of the biasing portion 158.

### 2. Modification Examples of Injection Molding Device

### 2.1. First Modification Example

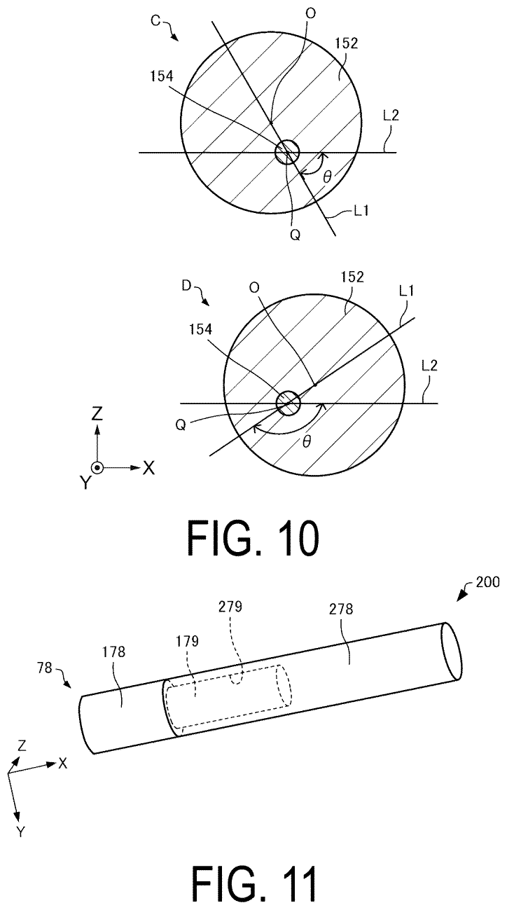

Next, an injection molding device according to a first modification example of the embodiment is described with reference to the drawings. FIG. 11 is a perspective view schematically illustrating a plunger 78 of an injection molding device 200 according to a first modification example of the present embodiment.

Hereinafter, in the injection molding device 200 according to the first modification example of the present embodiment, members having the same functions as the constituent members of the injection molding device 100 according to the present embodiment described above are denoted by the same reference numerals, and detailed description thereof is omitted.

In the injection molding device 100 described above, the plunger 78 is configured by one component.

In contrast, in the injection molding device 200, the plunger 78 is configured by a plurality of components. In the illustrated example, the plunger 78 is configured by two components including a first component 178 and a second component 278.

The first component 178 forms a root part of the plunger 78. For example, the first component 178 is coupled to the first wall portion 156a of the support portion 156. The first component 178 includes a protrusion portion 179 to be inserted into the second component. For example, a male screw is provided to the surface of the protrusion portion 179.

The second component 278 forms a distal portion of the plunger 78. The second component 278 is coupled to the first component 178. The first component 178 and the second component 278 are arrayed in the X-axis direction, that is, the moving direction of the plunger 78. The second component 278 includes an insertion hole 279 into which the protrusion portion 179 of the first component 178 is inserted. For example, on an inner surface of the insertion hole 279, a female screw fitted with the protrusion portion 179 is provided.

The first component 178 and the second component 278 are coupled to each other in a mutually removable manner. For example, when the male screw of the protrusion portion 179 and the female screw of the insertion hole 279 are fitted with each other, or the fitting therebetween is canceled, the first component 178 and the second component 278 can be removably coupled to each other.

Note that description is made above on an example in which the plunger 78 is configured by the two components, but the number of components of the plunger 78 is not particularly limited. Although omitted in illustration, the plunger 78 may be configured by three or more components.

In the injection molding device 200, the plunger 78 is configured by the plurality of components, and the plurality of components are arrayed in the moving direction of the plunger 78. Thus, in the injection molding device 200, the length of the plunger 78 can easily be changed.

### 2.2. Second Modification Example

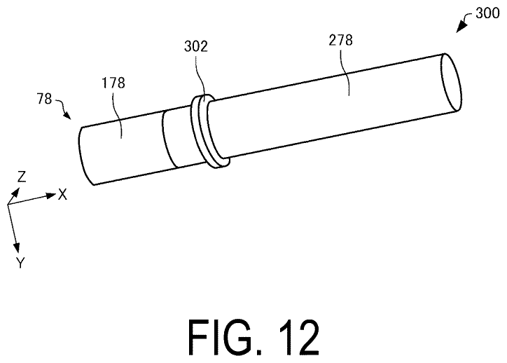

Next, an injection molding device according to a second modification example of the embodiment is described with reference to the drawings. FIG. 12 is a perspective view schematically illustrating a plunger 78 of an injection molding device 300 according to the second modification example of the present embodiment.

Hereinafter, in the injection molding device 300 according to the second modification example of the present embodiment, members having the same functions as the constituent members of the recording device 100 according to the present embodiment described above are denoted by the same reference numerals, and detailed description thereof is omitted.

Similarly to the injection molding device 200 described above, in the injection molding device 300, the plunger 78 includes the first component 178 and the second component 278. In the periphery of the second component 278, a protruding portion 302 is formed. In the illustrated example, the protruding portion 302 surrounds the entire circumference of the second component 278. The protruding portion 302 may be formed and integrated with the second component 278.

For acquisition of the length of the plunger 78, the control unit 56 controls the motor 79 to bring the protruding portion 302 into contact with the step surface 76 being an abutting part positioned in the moving direction of the plunger 78. Then, the control unit 56 detects the length of the plunger 78 by detecting a torque value of the motor 79. When the plunger 78 contacts with the step surface 76, a torque value of the motor 79 is increased. Thus, according to the length of the second component 278, a position at which the protruding portion 302 is provided can differ. With this, the length of the plunger can be detected based on the torque value.

In the injection molding device 300, the protruding portion 302 is formed in the periphery of the plunger 78, and the control unit 56 brings the protruding portion 302 formed at the plunger 78 into contact with the abutting part positioned in the moving direction of the plunger 78 to detect a torque value of the motor 79. With this, the length of the plunger 78 is detected. Thus, in the injection molding device 300, the length of the plunger 78 can easily be detected.

Note that, although omitted in illustration, the abutting part contacting with the protruding portion 302 may be provided in the −X-axis direction with respect to the plunger 78.

Further, although omitted in illustration, a recessed portion may be formed in the second component 278, and a protruding portion being the abutting part to be engaged with the recessed portion may be formed at the support portion 156. Further, the surface of the second component 278 that defines the recessed portion is brought into contact with the protruding portion. With this, the length of the plunger 78 may be detected.

### 2.3. Third Modified Example

Next, an injection molding device according to a third modification example of the present embodiment is described with reference to the drawings. Hereinafter, the injection molding device according to the third modification example of the present embodiment is described, focusing on differences from the above-mentioned example of the injection molding device 100 according to the present embodiment, and description for similar matters is omitted.

In the injection molding device 100 described above, the material supplied from the material supply unit 10 is an ABS resin.

In contrast, in the injection molding device according to the third modification example of the present embodiment, the material supplied from the material supply unit 10 is a material other than an ABS resin or a material obtained by adding another component to an ABS resin. In the injection molding device according to the present disclosure, a held pressure in a pressure holding phase can be increased. Thus, it is possible to increase the variety of resins that can be handled.

Examples of the material supplied from the material supply unit 10 includes materials containing various materials as main materials, such as a material having a thermoplastic property, a metal material, and a ceramic material. Herein, the “main material” refers to a main material that forms the shape of the molded item in the injection molding device, and refers to a material that constitutes 50% or more by mass of the molded item. The materials described above include a material in which a single main material is melted and a material in which some components included with a main material are melted together to form a paste.

For example, as the material having a thermoplastic property, a thermoplastic resin can be used. Examples of the thermoplastic resin include general-purpose engineering plastic and super engineering plastic.

Examples of the general-purpose engineering plastic include polypropylene (PP), polyethylene (PE), polyacetal (POM), polyvinyl chloride (PVC), polyamide (PA), polylactic acid (PLA), polyphenylene sulfide (PPS), polycarbonate (PC), modified polyphenylene ether, polybutylene terephthalate, and polyethylene terephthalate.

Examples of the super engineering plastic include polysulfone (PSU), polyethersulfone (PES), polyphenylene sulfide (PPS), polyarylate (PAR), polyimide (PI), polyamide-imide (PAI), polyetherimide (PEI), and polyether ether ketone (PEEK).

A pigment, metal, ceramic, and additives such as wax, a flame retardant, an antioxidant, and a thermal stabilizer may also be mixed in the material having a thermoplastic property. The material having a thermoplastic property is transitioned to a state of being plasticized and melted by rotation of the flat screw 110 and heating of the heater 130 in the plasticization unit 60. Further, the plasticized material thus generated is accumulated from the nozzle 80, and is solidified as the temperature decreases. The material having a thermoplastic property may be ejected from the nozzle 80 while the material is heater to the glass transition temperature of above and is completely melted.

In the plasticization unit 60, for example, a metal material may be used as a main material in place of the above-mentioned material having a thermoplastic property. In such a case, a component melted at the time of generating the plasticized material may be mixed in a powder material being a powdered metal material, and the resultant may be introduced into the plasticization unit 60.

Examples the metal material include magnesium (Mg), iron (Fe), cobalt (Co), chromium (Cr), aluminum (Al), titanium (Ti), copper (Cu), nickel (Ni) as individual metals, alloys containing one or more of these metals, maraging steel, stainless steel, cobalt-chromium-molybdenum, a titanium alloy, a nickel alloy, an aluminum alloy, a cobalt alloy, a cobalt-chromium alloy.

In the plasticization unit 60, a ceramic material can be used as a main material in place of the metal material described above. Examples the ceramic material include oxide ceramics such as silicon dioxide, titanium dioxide, aluminum oxide, zirconium oxide, and non-oxide ceramics such as aluminum nitride.

The powder material such as the metal material and the ceramic material, which is supplied from the material supply unit 10 may be a mixed material obtained by mixing a plurality types of powder of single metal, powder of an alloy, and powder of a ceramic material. Further, for example, the powder material such as the metal material and the ceramic material may be subjected to coating with the thermoplastic resin described above or other thermoplastic resins. In such a case, in the plasticization unit 60, the thermoplastic resin may exhibit fluidity when melted.

For example, a solvent may be added to the powder material such as the metal material and the ceramic material, which is supplied from the material supply unit 10. Examples of the solvent include: water; (poly)alkylene glycol monoalkyl ethers such as ethylene glycol monomethyl ether, ethylene glycol monoethyl ether, propylene glycol monomethyl ether, and propylene glycol monoethyl ether; acetate esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide solvents such as dimethyl sulfoxide and diethyl sulfoxide; pyridine solvents such as pyridine, γ-picoline, 2,6-lutidine; tetraalkylammonium acetate (for example, tetrabutylammonium acetate); and ionic liquids such as butyl carbitol acetate.

In addition, for example, a binder may be added to the powder material such as the metal material and the ceramic material, which is supplied from the material supply unit 10. Examples of the binder include an acrylic resin, an epoxy resin, a silicone resin, a cellulose-based resin, and other synthetic resins, and PLA, PA, PPS, PEEK, and other thermoplastic resins.

The embodiment and the modification examples described above are merely examples, and are not intended as limiting. For example, each embodiment and each modification example can also be combined together as appropriate.

The present disclosure includes configurations that are substantially identical to the configurations described in the embodiment, for example, configurations with identical functions, methods and results, or with identical objects and effects. Also, the present disclosure includes configurations obtained by replacing non-essential portions of the configurations described in the embodiment. In addition, the present disclosure includes configurations having the same operations and effects or can achieve the same objects as the configurations described in the embodiment. Further, the present disclosure includes configurations obtained by adding known techniques to the configurations described in the embodiment.

The following contents are derived from the embodiment and the modification examples described above.

An injection molding device according one mode includes a plasticization unit configured to plasticize a material to generate a plasticized material a nozzle having a nozzle opening and being configured to dispense the plasticized material through the nozzle opening, a sucking/dispensing unit including a cylinder communicating with the nozzle opening and being coupled to a flow path in which the plasticized material flows, a plunger configured to reciprocate inside the cylinder, a motor configured to drive the plunger, and a driving force transmission unit configured to transmit a driving force of the motor to the plunger, and a control unit configured to control the motor, wherein the control unit executes sucking processing of sucking the plasticized material into the cylinder by controlling a rotation speed of the motor and moving the plunger in a direction away from the flow path, and dispensing processing of dispensing the plasticized material inside the cylinder to the nozzle by controlling the rotation speed of the motor and moving the plunger in a direction approaching the flow path, the driving force transmission unit includes a rotary plate provided with a rotation axis at an eccentric position, and a support portion having a hole portion through which the rotation axis passes and being configured to support the plunger, the hole portion extends in a moving direction of the plunger, the support portion swings in an extending direction of the hole portion by rotation of the rotary plate, when the dispensing processing is terminated, an angle is larger than 90 degrees and smaller than 180 degrees, the angle being formed between a linear line connecting the rotation axis and a center of the rotary plate to each other and the moving direction of the plunger as viewed in a direction of the rotation axis, and the control unit controls the rotation speed of the motor according to the angle during the dispensing processing.

According to the injection molding device, a held pressure in a pressure holding phase can be increased without increasing the capacity of the motor.

In the injection molding device according to one aspect, the plunger may be configured by a plurality of components, and the plurality of components may removably be attached, and are arrayed in the moving direction of the plunger.

According to the injection molding device, the length of the plunger can easily be changed.

In the injection molding device according to one aspect, a recessed portion or a protruding portion may be formed in a periphery of the plunger, and the control unit may execute processing of detecting a length of the plunger by causing the recessed portion or the protruding portion that is formed at the plunger to contact with an abutting part positioned in the moving direction of the plunger and detecting a torque value of the motor.

According to the injection molding device, the length of the plunger can easily be changed.

In the injection molding device according to one aspect, according to the detected length of the plunger, the control unit may execute processing of generating control data for controlling the rotation speed of the motor or processing of selecting the control data from data stored in a storage unit.

According to the injection molding device, the sucking processing and the dispensing processing can be executed based on the control data according to the length of the plunger.

In the injection molding device according to one aspect, the control unit may execute processing of causing a display unit to display a changeable amount of the length of the plunger, based on chronological data relating to the torque value of the motor during the dispensing processing.

According to the injection molding device, a user can be notified of a changeable amount of the length of the plunger.

In the injection molding device according to one aspect, the control unit may execute processing of causing a display unit to display at least one of a maximum injection force according to the length of the plunger, a maximum held pressure, a maximum pressure holding time, or a moving speed of the plunger.

According to the injection molding device, a user can be notified of at least one of a maximum injection force according to the length of the plunger, a maximum held pressure, a maximum pressure holding time, or a moving speed of the plunger.

In the injection molding device according to one aspect, the support portion may include a wall portion being provided between the rotary plate and the plunger and being coupled to the plunger, the driving force transmission unit may include a biasing portion being provided between the wall portion and the rotary plate and biasing the wall portion in a direction approaching the flow path, the nozzle may include an opening/closing mechanism configured to open and close the nozzle opening, the opening/closing mechanism may be configured to open the nozzle opening when a pressure in the flow path is larger than a predetermined pressure, and a biasing force by the biasing portion may be smaller than a reaction force of the plunger against the predetermined pressure.

According to the injection molding device, the injection rate of the plasticized material can be normalized.

In the injection molding device according to one aspect, the control unit may execute the sucking processing while detecting the pressure in the flow path, and when the sucking processing is terminated, the biasing force of the biasing portion may be larger than the reaction force of the plunger against the pressure in the flow path.

According to the injection molding device, the dispensing processing can be started while the plunger can be moved by the biasing force of the biasing portion.

What is claimed is:

1. An injection molding device comprising:
a plasticization unit configured to plasticize a material to generate a plasticized material;
a nozzle having a nozzle opening and being configured to dispense the plasticized material through the nozzle opening;
a sucking/dispensing unit including:
a cylinder communicating with the nozzle opening and being coupled to a flow path in which the plasticized material flows;
a plunger configured to reciprocate inside the cylinder;
a motor configured to drive the plunger; and
a driving force transmission unit configured to transmit a driving force of the motor to the plunger; and
a control unit configured to control the motor, wherein
the control unit executes:
sucking processing of sucking the plasticized material into the cylinder by controlling a rotation speed of the motor and moving the plunger in a direction away from the flow path; and
dispensing processing of dispensing the plasticized material inside the cylinder to the nozzle by controlling the rotation speed of the motor and moving the plunger in a direction approaching the flow path,
the driving force transmission unit includes:
a rotary plate provided with a rotation axis at an eccentric position; and
a support portion having a hole portion through which the rotation axis passes and being configured to support the plunger,
the hole portion extends in a moving direction of the plunger,
the support portion swings in an extending direction of the hole portion by rotation of the rotary plate,
when the dispensing processing is terminated, an angle is larger than 90 degrees and smaller than 180 degrees, the angle being formed between a linear line connecting the rotation axis and a center of the rotary plate to each other and the moving direction of the plunger as viewed in a direction of the rotation axis, and
the control unit controls the rotation speed of the motor according to the angle during the dispensing processing.

2. An injection molding device according to claim 1, wherein
the plunger is configured by a plurality of components, and
the plurality of components are removably attached, and are arrayed in the moving direction of the plunger.

3. An injection molding device according to claim 1, wherein
a recessed portion or a protruding portion is formed in a periphery of the plunger, and
the control unit executes processing of detecting a length of the plunger by causing the recessed portion or the protruding portion that is formed at the plunger to contact with an abutting part positioned in the moving direction of the plunger and detecting a torque value of the motor.

4. An injection molding device according to claim 3, wherein
according to the detected length of the plunger, the control unit executes processing of generating control data for controlling the rotation speed of the motor or processing of selecting the control data from data stored in a storage unit.

5. An injection molding device according to claim 1, wherein
the control unit executes processing of causing a display unit to display a changeable amount of the length of the plunger, based on chronological data relating to the torque value of the motor during the dispensing processing.

6. An injection molding device according to claim 1, wherein
the control unit executes processing of causing a display unit to display at least one of a maximum injection force according to the length of the plunger, a maximum held pressure, a maximum pressure holding time, or a moving speed of the plunger.

7. An injection molding device according to claim 1, wherein
the support portion includes a wall portion being provided between the rotary plate and the plunger and being coupled to the plunger,
the driving force transmission unit includes a biasing portion being provided between the wall portion and the rotary plate and biasing the wall portion in a direction approaching the flow path,
the nozzle includes an opening/closing mechanism configured to open and close the nozzle opening,
the opening/closing mechanism is configured to open the nozzle opening when a pressure in the flow path is larger than a predetermined pressure, and
a biasing force by the biasing portion is smaller than a reaction force of the plunger against the predetermined pressure.

8. An injection molding device according to claim 7, wherein
the control unit executes the sucking processing while detecting the pressure in the flow path, and
when the sucking processing is terminated, the biasing force of the biasing portion is larger than the reaction force of the plunger against the pressure in the flow path.
